(19) United States
(12) Patent Application Publication
(10) Pub. No.: US 2024/0177232 A1
(43) Pub. Date: May 30, 2024

(54) CONTAINERIZED TRANSACTION MANAGEMENT SYSTEM AND METHOD AND RESULTING GRAPHICAL USER INTERFACE

(71) Applicant: Nader YASSA, Plano, TX (US)

(72) Inventors: Nader YASSA, Plano, TX (US); Kevin OSBECK, Plano, TX (US); Steven GILMAN, Jersey City, NJ (US)

(21) Appl. No.: 18/518,306

(22) Filed: Nov. 22, 2023

Related U.S. Application Data
(60) Provisional application No. 63/429,100, filed on Nov. 30, 2022.

(51) Int. Cl. G06Q 40/02; G06F 9/451; G06Q 40/06

(52) U.S. Cl. CPC G06Q 40/02; G06F 9/451; G06Q 40/06

(57) ABSTRACT

A containerized transaction management method is disclosed. The method comprises categorizing, by a transaction categorizer, a transaction as a credit card payment transaction or a transfer transaction and determining, by a container assigner, whether a counterpart transaction is identified based on applying container logic. The method also comprises placing, by the container assigner, the transaction in a buffer based on a flag of the container if no counterpart transaction is identified and periodically retesting, by the container assigner, the transaction to determine if a new matching counterpart transaction becomes available within a predefined amount of time. The method additionally comprises providing, by a display engine, a client dashboard to a user device for display on a graphical user interface (GUI) of the user device, wherein the client dashboard comprises a graphical representation that does not include the transaction in the buffer.

### CROSS-REFERENCE TO RELATED APPLICATIONS

The present application claims priority to U.S. Provisional Application No. 63/429,100 filed with the United States Patent and Trademark Office on Nov. 30, 2022, and entitled “CONTAINERIZED TRANSACTION MANAGEMENT SYSTEM AND METHOD AND RESULTING GRAPHICAL USER INTERFACE,” which is incorporated herein by reference in their entirety for all purposes.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Individuals may undergo numerous transactions in a day. Tracking and management of such transactions can be technologically challenging. Additionally, analyzing such transactions and providing real-time, helpful, and relevant information about those transactions to end users can be technologically challenging.

### SUMMARY

In an embodiment, a containerized transaction management method is disclosed. The method comprises receiving, by a management platform, a transaction associated with a client from an aggregator and categorizing, by a transaction categorizer stored in a non-transitory memory of the management platform and executed by a processor of the management platform, the transaction as a credit card payment transaction or a transfer transaction. The method also comprises applying, by a container assigner stored in the non-transitory memory and executed by the processor, container logic based on a determination that the transaction is a credit card payment transaction or a transfer transaction, determining, by the container assigner, whether a counterpart transaction is identified based on applying the container logic, and in response to a determination that no counterpart transaction is identified, placing, by the container assigner, the transaction in a buffer based on a flag of the container. The method additionally comprises providing, by a display engine stored in the non-transitory memory and executed by the processor, a client dashboard to a user device for display on a graphical user interface (GUI) of the user device. The client dashboard comprises a graphical representation that does not include the transaction in the buffer. The method further comprises periodically retesting, by the container assigner, the transaction to determine if a new matching counterpart transaction becomes available within a predefined amount of time.

In another embodiment, a containerized transaction management system is disclosed. The system comprises a management platform that includes a non-transitory memory, a processor; and a display engine stored in the non-transitory memory that, when executed by the processor, provides a transaction category screen to a user device associated with a client for display a graphical user interface (GUI) of the user device. The transaction category screen includes a graphical representation of transaction data based on a category associated with each transaction. The graphical representation comprises an actual bar, a plan bar, and an expected indicator for each category. The display engine also receives an indication of a user selection of the actual bar for a first category of transactions from the user device, and in response to receipt of the indication of the user selection of the actual bar for the first category of transactions, provides a plurality of transactions associated with the first category of transactions to the user for display on the GUI. The display engine further receives a user inputted instruction from the user device to assign a first transaction of the plurality of transactions associated with the first category of transactions to a fund, and in response to receipt of the user inputted instruction, provides an updated transaction category screen to the user device for display on the GUI. The updated transaction category screen includes an updated graphical representation of updated transaction data for the first category of transactions. The updated graphical representation comprises an updated plan bar expended by an amount of the first transaction.

In yet another embodiment, a containerized transaction management method is disclosed. The method comprises receiving, by a management platform, a plurality of transactions associated with a client from an aggregator and categorizing, by a transaction categorizer stored in a non-transitory memory of the management platform and executed by a processor of the management platform, the plurality of transactions based on applying three tiers of categorization such that each transaction is as associated with a category of a plurality of categories. The three tiers of categorization applied to a first transaction of the plurality of transactions comprises a first tier of categorization based on applying a client rule when the client rule for the first transaction exists, a second tier of categorization based on applying a system rule when no client rule for the first transaction exists but the system rule for the first transaction exists, and a third tier of categorization based on applying a default categorization determined based on externally provided transaction information when no client rule or system rule exists for the first transaction. The method also comprises assigning, by a container assigner stored in the non-transitory memory and executed by the processor, at least some of the plurality of transactions to containers based on container rules and linking, by a linkage component stored in the non-transitory memory and executed by the processor, at least one container to an asset. The method further comprises providing, by a display engine stored in the non-transitory memory and executed by the processor, a client dashboard to a user device for display on a graphical user interface of the user device. The client dashboard includes a graphical representation of the plurality of transactions based on the associated categories and the assigned containers.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a containerized transaction management system according to an embodiment of the disclosure.

FIG. 2 is a block diagram of a container according to an embodiment of the disclosure.

FIG. 3 is a screenshot of a client dashboard according to an embodiment of the disclosure.

FIGS. 4A-4C are a series of screenshots involving a net worth screen according to an embodiment of the disclosure.

FIG. 5 is a screenshot of a cash flow mapping screen according to an embodiment of the disclosure.

FIG. 6 is a screenshot illustrating a drill down category screen along with a drill down transaction functionality according to an embodiment of the disclosure.

FIG. 7 is a screenshot illustrating a drill down metadata functionality including an asset linkage according to an embodiment of the disclosure.

FIGS. 8A-8C are a series of screenshots assigning a transaction to a fund according to an embodiment of the disclosure.

FIG. 9 is screenshot of a drill down category screen along with selectable transaction options.

FIGS. 10A and 10B are screenshots based on selecting transaction options.

FIG. 11 is a screenshot of a life time machine according to an embodiment of the disclosure.

FIG. 12 is a screenshot of a bill capture function according to an embodiment of the disclosure.

FIGS. 13A and 13B are a flow chart of a method according to an embodiment of the disclosure.

FIGS. 14A and 14B are a flow chart of a method according to an embodiment of the disclosure.

FIG. 15 is a flow chart of a method according to an embodiment of the disclosure.

FIG. 16 is a block diagram of a computer system implemented within the containerized transaction management system of FIG. 1 according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Current personal financial management solutions include applications that collect transaction data from bank accounts to sell more products or services, financial literacy that provides knowledge and coaching, and financial planners that are focused on selling financial products. However, each of these solutions individually and collectively fall short for providing a client lifestyle management. To overcome the shortcomings of the available personal financial management solutions currently available, the pending disclosure is directed to a comprehensive, integrated, and end-to-end management platform that delivers dynamic and real-time data to end users. The management platform, or more specifically a transaction categorizer on the management platform, initially categorizes each transaction received from financial institution servers using a three-tiered categorization approach. The management platform dynamically and in real-time categorizing transactions. In particular, a transaction categorizer on the management platform will categorize each transaction. The three tiers to the categorization may include client rules that are customizable by the client, system rules that apply globally irrespective of individuals, and default categorization determined based on external information provided with the transaction. The management platform may use machine learning (ML) to enhance the categorization. For example, an ML component may suggest rules for categorization including whether a client rule should be promoted to a system rule.

In additional to categorizing transactions, the management platform, or more specifically a container assigner on the management platform, assigns transactions to containers and enables linkages to assets or liabilities. Containers are data structures that store objects. The containers may associate certain transactions together and include any rules applied. For bills and income elements, the container may tie transaction(s) to a particular asset or liability. The linkages integrate the transaction data with assets or liabilities and enable the management platform to provide insight into the cost/return on investments to clients. The ML component could also assist with linkages. For example, the ML component could suggest rules for linking a container or a transaction to an asset (e.g., based on geography data).

As part of categorization and assigning transactions to containers, sometimes issues may arise with certain types of transactions such as transfer transactions between accounts and credit card payment transactions. If the transaction categorizer determines that a transaction is a credit card transaction or a transfer of money between accounts, the container assigner applies container logic. Based on the container logic, the transaction may be placed in a buffer or holding area while the container assigner tries to locate a matching counterpart transaction. The container assigner may try to locate a matching counterpart transaction by looking at the source identity, the amount, and/or the date. If a match is found, the transaction is released from the buffer. Each transaction may be held in the buffer for a predetermined amount of time (e.g., five days or another amount of time) to see if a matching counterpart transaction comes in. If no match is found after the predetermined amount of time, the transaction may be displayed in the client dashboard or an exception may be issued for the client to examine the transaction. While in the buffer awaiting identification of a counterpart transaction, the transaction is not displayed in a cash flow presented to the client so as to not potentially confuse the client. This prevents double counting of cash requirements and/or requiring the client to find and ignore “balance sheet” transactions such as paying a credit card balance or transferring money from one account to another.

The management platform via a display engine provides a client dashboard to a graphical user interface (GUI) of a user device associated with the client. The client dashboard helps the client strategically plan for their future and tactically manage their activities. The client dashboard is a tactical tool to help the client implement their strategic plan. The client dashboard is dynamic and adjusted in real-time by the management platform based on the categorization and container assignments being performed by the management platform. The client dashboard comprises, for each element (e.g., income, bills, spending, investment contributions, funds, etc.), (1) an actual bar that reflects actual transactions associated with that element, (2) a plan bar that reflects what was created in the plan for that period for that element, and (3) an expected indicator (on the plan bar) that reflects where the end user is within period in question for that element. There is a drill down functionality with the client dashboard. For example, when an element is selected, the management platform via the display engine provides transaction data at the category level. This transaction data may be in the form of an actual bar, a plan bar, and an expected indicator at the category level. If the client selects the transaction data for a particular category, each transaction within that particular category is displayed to the client, and the client can sort the displayed transactions by various criteria (e.g., vendor, date, account the transaction came out of, etc.).

One of the challenges with the client dashboard involves management of the expected indicator as well as management of the plan bar in the client dashboard under various circumstances. The first circumstance is with regard to periodic events such as income and bills that can be inventoried. In this circumstance, the management platform collects metadata that shows when the bill is expected to be paid or income is to be received and the expected indicator is moved on that date. This helps the client dashboard better align with the client's expectations.

The second circumstance is with respect to monthly normalization of non-monthly periodic expenses (e.g., property taxes). In this circumstance and using non-limiting property tax example, the management platform may collect metadata that shows that a $12,000 property tax bill will be due in December. The management platform can divide that amount on a monthly basis (or whatever the client selects as the basis)—$1,000 a month, which affects their income. The management platform may then normalize the bill for the plan to enable the client to understand their monthly pace, but the plan bar in the client dashboard does not include the $1,000 each month. Rather, in December, the plan bar would be $12,000, and when the property tax bill is paid, the display engine would move the expected indicator to the end of the plan bar ($12,000).

The third circumstance is with regard to assigning a transaction that has a category to a fund. In this circumstance, the management platform allows a transaction to be assigned to a fund, which will move the dollar amount from the fund balance and extend the plan bar for the category by that dollar amount. In an embodiment, the expected indicator may also move back by the dollar amount. Take the following fuel example as a non-limiting example to illustrate assignment of a transaction to fund. The client has made a plan every month to spend $300 on fuel. The client also made a plan to add $500 a month to their holiday expenses. In December when the client drives to Grandma's house and spends $800 on gas, the dashboard will look like the client is $500 over budget on fuel. However, as soon as the management platform assigns that transaction assigned to the fuel category to the holiday fund based on the client's instruction, the holiday fund balance will decrease by $800 and the plan bar on the dashboard will be extended $800. The expected indicator may also be moved back by $800. The assignment of transactions to funds and resulting management of the elements within the dashboard as a result of such assignment allows the client to manage their behavior and assign activities to a fund without looking like they are going over budget.

The management platform via the display engine may also provide a life time machine screen to the GUI of the user device associated with the client. The graphical data represented in the life time machine screen is based on actual transactions and category as well as container level predictions. Additionally, the graphical data represented in the life time machine screen considers non-traditional investments such as rental property that typical brokerage firms do not consider.

The management platform uses a much more subtle and varied approach, which includes linking with assets or liabilities and categorization, which gives results in more granular assumptions. For example, the management platform tracks multiple asset types, not only for traditional brokerage investments but also for investments such as rental and investment property, and for other assets which provide potential return on investment over time. This provides a more comprehensive approach. As discussed above, the management platform links transactions to assets of types in addition to applying categorizations. The linkages integrate actual transaction data with assets and provide insight into the cost/return on our investments. The management platform also identifies incomes by source type and links them to assets where appropriate. Additionally, the management platform enables expenses to be categorized, which reflect (1) discretionary/essential, (2) inflation aware, (3) tax deductible/tax related, and (4) association with an asset (by linkage replacing the categorization). Knowing this allows a better and more granularly forecast for the client's future to accomplish an end-to-end result.

The management platform provides a unique data framework, which is architected to incorporate income, transactions, and assets, along with categories of expenses for the transactions, containerized transactions, linkages to assets, and linkages for transactions. Based on the model created by this data framework incorporating these contextualized elements, the management platform applies calculators, which create or project reports driven by the relationships and time. The management platform also provides the life time machine screen, which brings in a manageable set of assumptions and leverages the more complex set of relationships built, in order to provide more granular and nuanced, future prediction results to the client. The management platform uses assumptions in conjunction with many other facts, transactions, and assumptions to bring it all together for a particular investment, and then integrates that investment with every other investment and retirement (tax-advantaged) accounts, and the client's income and cash requirements for the rest of their life in the life time machine screen. The life time machine screen brings together all facts, assumptions, and actual transaction related to every investment, non-tax advantaged and tax-advantaged account, income and expense transactions, and allows unlimited future-casting of every element. The management platform allows linking transactions to assets. When an investment is identified and the management platform links the asset to the investment, the transactions are automatically pulled into that investment and provides all of the information needed to report on actual performance, predict the future, and integrate with every other part of the client's financial existence. The management platform enables connectivity from transaction to asset to investment to other investments to cashflow over time.

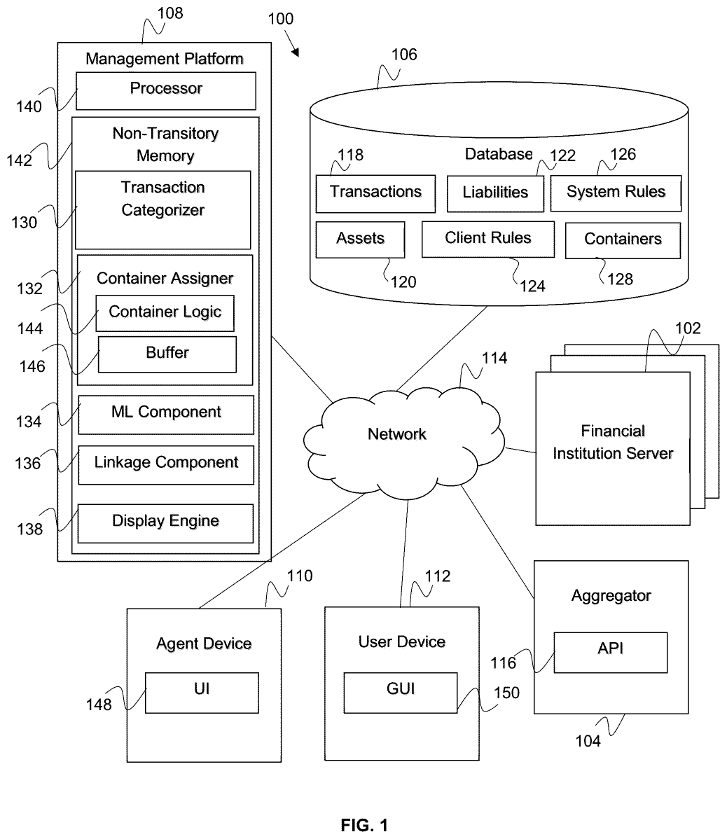

Turning now to FIG. 1, a containerized transaction management system 100 is described. In an embodiment, the system 100 comprises one or more financial institution servers 102, an aggregator 104, a database 106, a management platform 108, an agent device 110, a user device 112, and a network 114. The one or more financial institution servers may be associated with bank accounts, credit cards, or other financial institutions. In an embodiment, the aggregator 104 comprises an application programming interface (API) 116 that interfaces with the one or more financial institution servers 102 and receives a plurality of transactions 118. The plurality of transactions 118 may be financial transactions. The plurality of transactions 118 may be stored in the database 106. Each of the plurality of transactions 118 received from the one or more financial institution servers 102 may comprise metadata including one or more of an amount of the transaction, a date of the transaction, a receiving party of the transaction, a sending party of the transaction, or other transaction related data. Different metadata may be sent with each of the transactions 118 depending on which financial institution server 102 is providing the transactions 118.

The database 106 may comprise the transactions 118, assets 120, liabilities 122, and client rules 124 for one or more clients. The database may also comprise system rules 126 and containers 128. As mentioned above, the transactions 118 are provided by the financial institution server(s) 102 via the API 116 of the aggregator 104. The assets 120, the liabilities 122, and the client rules 124 associated with a particular client may be defined via a user interface (UI) 148 of the agent device 110 associated with an agent tasked with helping to service the client. The assets 120 for a particular client may comprise items that the particular client owns that can provide future economic benefit (e.g., a home, a rental property, savings account, checking account, retirement account, tax deferred account, a brokerage/investment account, etc.). The liabilities 122 for a particular client may comprise things the particular client owes to other parties (e.g., credit card balances, auto loans, student loans, mortgage, personal loans, etc.). The client rules 124 for a particular client may comprise client categorization rules defined by the particular client. For example, the client categorization rules may define that certain transactions for the particular client be associated with a particular category. The client rules 124 for a particular client may also comprise client container rules. For example, the client container rules may define a new container be formed for certain transactions for the particular client. The client rules 124 are applied on a client by client basis. The agent device 110 may be a mobile phone, a smart phone, a personal digital assistant (PDA), a wearable computer, a headset computer, a laptop computer, a notebook computer, a tablet computer, a desktop computer, or another type of electronic device.

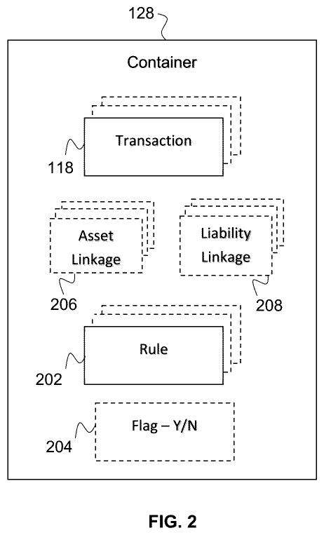

The system rules 126 may comprise categorization rules for the transactions 118. The system rules 126 may be applied for all clients. Some of the system rules 126 may be previous client rules 124 that have been promoted from a client rule to a system rule. In an embodiment, the containers 128 are data structures that store objects. The containers may associate certain transactions 118 together, tie the certain transactions to a particular asset 120 or liability 122, and link any of the client rules 124 and/or the system rules 126 applied. The containers 128 will be discussed in more detail with respect to FIG. 2.

The management platform 108 may comprise a transaction categorizer 130, a container assigner 132, a machine learning (ML) component 134, a linkage component 136, and a display engine 138. Each of the transaction categorizer 130, the container assigner 132, the ML component 134, the linkage component 136, and the display engine 138 may be stored in a non-transitory memory 142 of the management platform 108 and executed by a processor 140 of the management platform 108.

In an embodiment, the transaction categorizer 130 dynamically and in real time categorizes transactions 118 as they are received from the financial institution server(s) 102 via the API 116 of the aggregator 104 in order to provide the most up-to-date information to each client. Initially, the transaction categorizer 130 standardizes external data received from the aggregator 104. For example, some received transactions may be defined based on third party data as groceries and other received transactions may be defined based on different third-party data as grocery store. The transaction categorizer 130 may standardize these transactions as associated with food rather than relying on the thirty party's categorization of the transaction. In this way, the management platform 108 is considered aggregator agnostic.

The transaction categorizer 130 may implement a three-tiered categorization approach to categorize each transactions 118. The transaction categorizer 130 may implement a first tier of categorization that comprises selects and applies one or more of the client rules 124 associated with the particular client to the transaction 118 to determine a category for the transaction 118. If no client rules 124 apply, the transaction categorizer 130 may implement a second tier of categorization that comprises selecting and applying one or more of the system rules 126 to determine a category for the transaction 118. If no client rules 124 apply and no system rules 126 apply, the transaction categorizer 130 may categorize the transaction 118 using the default categorization determined based on the initial standardization process discussed above.

A non-limiting example that illustrates the three-tiered categorization approach is that a first client may travel to Sun Valley Resort in Idaho and eat at a restaurant. The transaction generated based on eating at that restaurant may just come generically from Sun Valley Resort. The initial standardization performed by the transaction categorizer 130 may categorize an incoming transaction as entertainment or a different category based on the external data received with the transaction. However, the first client may say that that particular transaction was not for entertainment, but rather a restaurant. Thus, the management platform 108 may create a new system rule that defines any transactions received from Sun Valley Resort as a restaurant transaction rather than entertainment based on the new system rule. That new system rule may then be applied to other clients with transactions from Sun Valley Resort. A second client may then decide that any transactions from Sun Valley Resort be categorized as vacation or a vacation fund as opposed to a restaurant since he or she only travels there for vacation. Thus, the management platform 108 may create a new client rule for the second client that defines any transactions received from Sun Valley Resort for the second client be categorized as vacation.

The three tiers of categorization help promote processing efficiencies by not necessarily having every transaction 118 migrate through all three tiers, while also promoting accurate categorization. The ML component 134 may employ machine learning functionality to suggest potential categorization rules based on the categorization being performed by the transaction categorizer 130. For example, the ML component 134 may suggest when a client rule 124 should be promoted to a system rule 126 based on observing the categorization being performed by the transaction categorizer 130.

As discussed above, the transaction categorizer 130 selects a category to associate with each transaction 118. Categories may be organized by element. Elements may comprise income, bills, spending, investment contributions, funds, or other elements. There may be different categories for each element. For example, for the income element, there may be a plurality of income categories (e.g., bank deposit, child support income, dividend income, interest income, investment distributions, other income, rental income, salaries and wages, social security etc.). For the bills element, there may be a plurality of bill categories (e.g., auto and transport, beauty, cable satellite and telecom, charitable giving, etc.). For the spending element, there may be a plurality of spending categories (e.g., auto and transport, bank fees, beauty, cash withdrawals, charitable giving, check, child care, clothing, community service etc.). For the investment contributions element, there may be a plurality of investment contribution categories (e.g., health savings account, miscellaneous contributions, etc.). For the fund element, there may be one or more fund categories depending on the funds a particular client establishes. There may be more or less elements and more or less and/or different categories for each element without departing from the spirit or scope of the present disclosure.

After a transaction 118 is categorized, the container assigner 132 may determine whether to assign the transaction to one of the containers 128 based on the client rules 124. Recall that the client rules 124 may comprise container rules and categorization rules. The containers 128 may be client specific. In some embodiments, the container assigner 132 may apply a container rule, create a new container that is not yet in existence as part of the containers 128, and assign one or more of the transactions 118 to the new container. In an embodiment, not all transactions 118 are assigned to one of the containers 128. The containers 128 may be data structures that store objects. The containers 128 may associate certain transactions 118 for a client together, tie the certain transactions to a particular asset 120 or liability 122, and link any of the client rules 124 and/or the system rules 126 applied. The containers 128 will be discussed in more detail with respect to FIG. 2.

In certain circumstances, issues may arise with the handling of certain categories of transactions such as transfer transactions between accounts and credit card payment transactions. For example, in a transfer scenario, if a client is transferring money between bank accounts, but only the transfer out of a bank account is currently represented in the transactions 118 (i.e., it has not been received or deposited in the other bank account), displaying of such information to the client would be misleading and confusing as it would look like only a negative transaction has occurred (withdrawal from a bank account). Similar issues arise on the credit card payment transaction front. For example, in a credit card transaction scenario, if a client is paying a credit card from their bank account, but only the transfer out of the bank account is currently represented in the transactions 118 (i.e., it has not been received or applied to the credit card account), displaying of such information to the client would be misleading and confusing as it would look like only a negative transaction has occurred.

If a transaction is determined by the transaction categorizer 130 to be a credit card payment transaction or a transfer transaction, the container assigner 132 may apply container logic 144 to address the issues identified above. In an embodiment, there may be a first container logic applied with a transfer transaction and a second container logic applied with a credit card payment transaction.

Turning first to a transfer transaction, the container assigner 132 may apply the container logic 144. Based on applying the container logic 144, the container assigner 132 may group negative transactions by their source into transfer received containers. For a negative transfer transaction, a source is a connected account such as a receiving bank account (e.g., a receiving checking account). In an embodiment, with transfer transactions, there is one source per container such that each receiving account source container only has negative transactions. Based on applying the container logic 144, the container assigner 132 may also group positive transactions from connected bank accounts into outgoing transfer containers in the same way as how the negative transactions are grouped into transfer received containers. If there is a transfer from two or more bank accounts to a single receiving bank account, the container assigner 132 may group the two or more outgoing transfer accounts and associated transactions into the same outgoing transfer container based on the container logic 144.

Based on applying the container logic 144, for a given transfer transaction, the container assigner 132 may attempt to identify a counterpart transfer transaction, which is a transaction of exactly the same amount, but with an opposite sign, and with a transaction date that is within a predetermined amount of time of the given transfer transaction. The predetermined amount of time may be four days, five days, six days, seven days, or some other amount of time. In an embodiment, the container assigner 132 places a transaction determined to be a transfer and/or its associated container in a buffer 146 or holding area while the container assigner 132 attempts to locate a match based on a flag of the associated container being set to “yes.” While in the buffer 146, the transfer transaction is not displayed in the client dashboard presented to the client via the GUI 150 so as to not potentially confuse the client. The container assigner 132 may attempt to locate a match based on the source identity, the amount, and/or a date. If a match is found, the transfer transaction is released or removed from the buffer 146.

Each transfer transaction may be held in the buffer 146 for a predetermined amount of time to see if a counterpart transfer transaction match is found. As discussed above, the predetermined amount of time may be four days, five days, six days, seven days, or some other amount of time. The container assigner 132 may periodically retest any transfer transactions in the buffer 146 (e.g., daily or at some other frequency) for the predetermined amount of time to see if a new match becomes available as time passes. If no counterpart transaction match is found within the predetermined amount of time, the container assigner 132 may release the transaction, and the transaction may be displayed on the client dashboard. Alternatively, if no counterpart transaction match is found within the predetermined amount of time, the container assigner 132 may issue an exception for a user to examine the transfer transaction. The exception may be addressed by the agent via the UI 148 of the agent device 110 and/or the client via the GUI 150 of the user device 112.

Turning next to a credit card payment transaction, the container assigner 132 may apply the container logic 144. Based on applying the container logic 144, the container assigner 132 may group negative transactions by their source into payment received containers. For a negative credit card payment transaction, a source is a connected account such as a credit card account. In an embodiment, with credit card payment transactions, there is one source per container such that each payment received source container only has negative transactions. Based on applying the container logic 144, the container assigner 132 may also group positive transactions from connected bank accounts into bill payment containers in the same way as how the negative transactions are grouped into payment received containers. If there are credit card payments from two or more bank accounts to the same credit card account, the container assigner 132 may group the two or more bank accounts and associated transactions into the same outgoing payment container based on the container logic 144.

Based on applying the container logic 144, for a given credit card payment transaction, the container assigner 132 may attempt to identify a counterpart transaction, which is a transaction of exactly the same amount, but with an opposite sign, and with a transaction date that is within a predetermined amount of time the given credit card payment transaction. The predetermined amount of time may be four days, five days, six days, seven days, or some other amount of time. In an embodiment, the container assigner 132 places a transaction determined to be a credit card payment transaction and/or its associated container in the buffer 146 while the container assigner 132 attempts to locate a match based on a flag of the associated container being set to “yes.” While in the buffer 146, the credit card payment transaction is not displayed in the client dashboard presented to the client via the GUI 150 so as to not potentially confuse the client. The container assigner 132 may attempt to locate a match based on the source identity, the amount, and/or a date. If a match is found, the credit card payment transaction is released or removed from the buffer 146.

Each credit card payment transaction may be held in the buffer 146 for a predetermined amount of time to see if a counterpart transaction match is found. As discussed above, the predetermined amount of time may be four days, five days, six days, seven days, or some other amount of time. The container assigner 132 may periodically retest any credit card payment transactions in the buffer 146 (e.g., daily or at some other frequency) for the predetermined amount of time to see if a new match becomes available as time passes. If no counterpart transaction match is found within the predetermined amount of time, the container assigner 132 may release the transaction, and the transaction may be displayed on the client dashboard. Alternatively, if no counterpart transaction match is found within the predetermined amount of time, the container assigner 132 may issue an exception for a user to examine the transfer transaction. The exception may be addressed by the agent via the UI 148 of the agent device 110 and/or the client via the GUI 150 of the user device 112.

The linkage component 136 of the management platform 108 may link a transaction 118 to an asset 120, a liability 122, or an investment. The linkage component 136 may link a container 128 (and its associated transactions 118) to an asset 120 or liability 122. For example, at the bills and income elements, the linkage component 136 may link a container 128 to an asset 120 or liability 122. The linkage component 136 may determine linkages based on instruction from the client received via the user device 112. Additionally or alternatively, the linkage component 136 may determine linkages based on instruction from the agent device 110 associated with the agent tasked with helping to service the client. The agent may work with the client to determine appropriate linkages for transactions 118 and/or containers 128 with corresponding assets 120, liabilities 122, or investments.

As one non-limiting example to illustrate the value of transaction and container linkages to assets and/or investments, assume that the client has a rental property. That rental property has a utility bill associated with it. The utility bill is an actual transaction that is used to predict the future transactions. Since a utility bill is an essential (lasts forever) bill and is affected by inflation (i.e., it is inflation aware), then this will affect the cash flow performance of the asset and in turn the net present value of that investment. This drives multiple information data points with regard to performance and decision making related to asset liquidation tied to automatic distribution and meeting future lifestyle cash requirement demands.

In an embodiment, the ML component 134 assists with linkages by suggesting rules for linking to an asset 120 or liability 122 based on observing linking performed by the linkage component 136. For example, as one non-limiting example, the management platform 108 may know that a client has a rental property in Florida. When a transaction 118 comprising a utility bill from Florida is inputted into the system 100, the ML component 134 may suggest based on geography data that the bill transaction should be linked to the Florida rental property asset. The client or the agent may be able to approve or decline the suggestion from the ML component 134 using the agent device 110 or the user device 112.

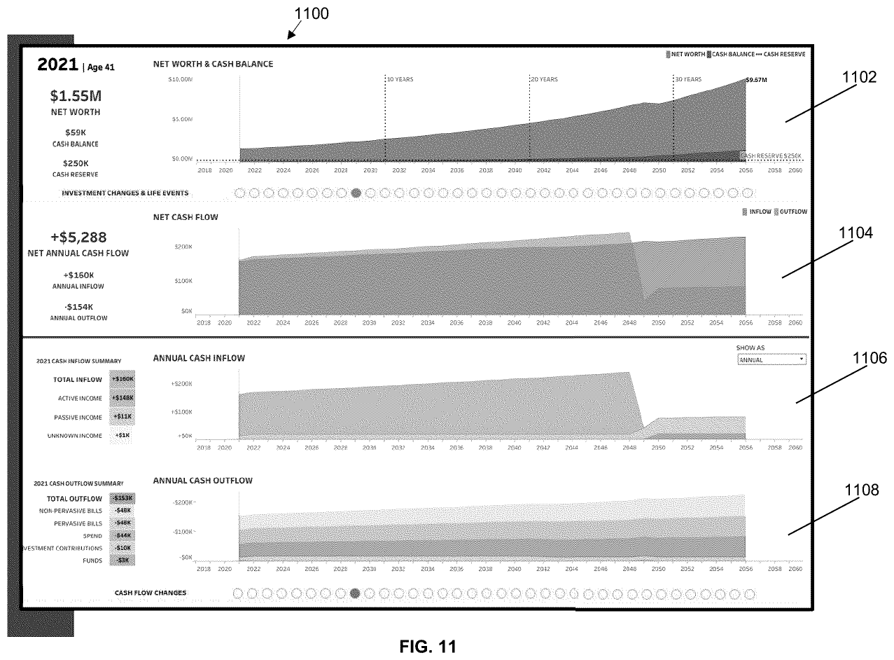

The linkage component 136 may also link an asset to an investment. This enables all of the transactions linked to the asset via the container to also be linked to the investment. Investment information for the investment may be provided by the display engine 138 to the user device 112 for display on the GUI 150. The investment information along with additional asset to investment linkages for other investments and additional information such as other investment and retirement (tax-advantaged) accounts and the client's income and cash requirements for the rest of their life may be combined to produce a life time machine screen, which is discussed below with reference to FIG. 11.

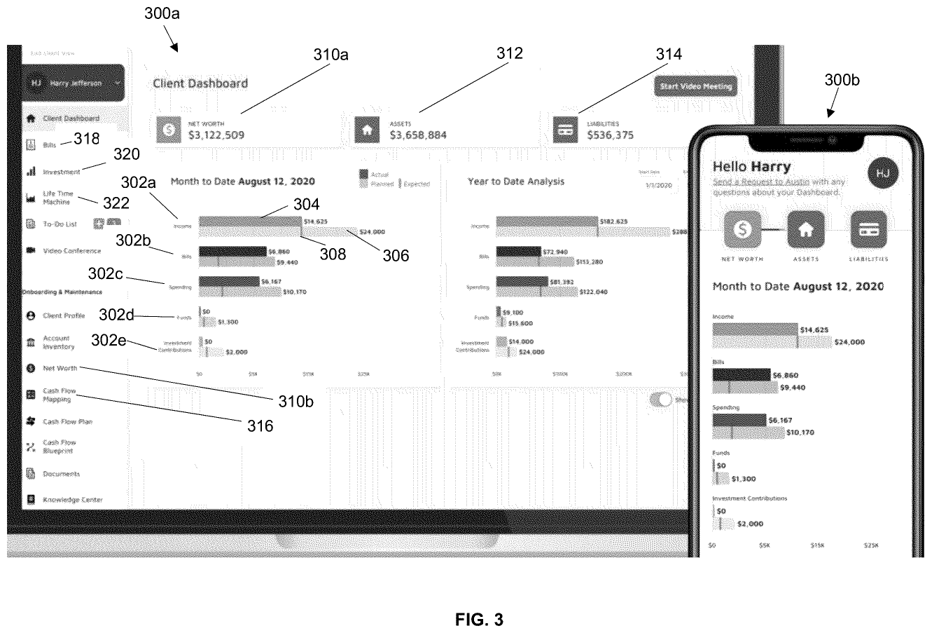

The categorization performed by the transaction categorizer 130, the assignment performed by the container assigner 132, and the linkage performed by the linkage component 136 establish a data framework specifically architected to provide a comprehensive, integrated, and end-to-end view for clients dynamically as transactions are received and in near real time. This will become clearer as each of the various screenshots are discussed in FIGS. 3-9 that follow. The display engine 138 of the management platform 108 may render the various graphical user interfaces represented in the screenshots discussed in FIGS. 3-9 to the user device 112 for display.

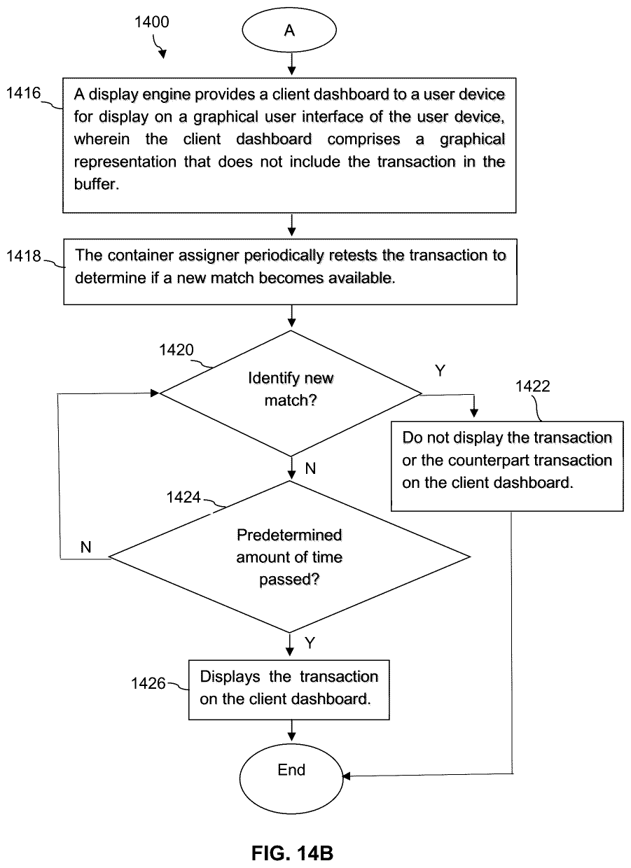

Network 114 may comprise one or more public networks, one or more private networks, or a combination thereof. Each of the financial institution server(s) 102, the aggregator 104, and the management platform 108 may be a general-purpose computer described in more detail in regard to FIG. 14A and 14B. While represented as separate from the management platform 108, in some embodiments, the aggregator 104 may be a part of the management platform 108. Only a single database 106 is illustrated in FIG. 1, but a plurality of databases may instead be present with the information stored in the database 106 split among the plurality of databases without departing from the spirit or scope of the present disclosure.

Turning now to FIG. 2, a block diagram of a container 128 is described. The container 128 may comprise one or more transactions 118 and one or more rules 202 associated with the corresponding transactions 118 and/or the container 128. In some embodiments, the one or more rules 202 may include any client rules 124 applied to the one or more transactions 118 and/or any system rules 126 applied to the one or more transactions 118.

The container 128 may also comprise an asset linkage 206 or a liability linkage 208. Such linkages 206 or 208 enable integration of transaction data with corresponding assets 120 or liabilities 122, which enables a more comprehensive insight into cost/return on the client's investments.

The container 128 may also comprise a flag 204. In an embodiment, the flag 204 is used by the display engine 138 to determine what transactions 118 to display to the client in the GUI 150 of the user device 112. If the flag is set to “yes”, the one or more transactions 118 from the container 128 do not appear in a client dashboard presented to the client via the GUI 150 of the user device 112. If the flag 204 is set to “no”, the one or more transactions 118 from the container 128 do appear in the client dashboard presented to the client via the GUI 150 of the user device 112. The flag 204 may be present in containers storing transfer transactions and credit card payment transactions as discussed above to try to reduce the likelihood of confusing the client with prematurely displaying partial transactions.

Turning now to FIG. 3, a screenshot of a client dashboard 300a and 300b is disclosed. The client dashboard 300a and 300b may be provided by the display engine 138 and displayed via the GUI 150 on the user device 112. The client dashboard 300a and 300b is a tactical tool to help the client implement their strategic plan. The client dashboard 300a and 300b is dynamic and adjusted in real-time based on incoming transactions and the categorization and container assignment of those incoming transactions performed by the management platform 108. The client dashboard 300a may illustrate what is presented when the user device 112 is a computer (e.g., a laptop or desktop) while the client dashboard 300b may illustrate what is presented when the user device 112 is a mobile device. The client dashboard 300a and 300b may present a month view and a year to date view for the client. On either view, a plurality of elements are listed including income 302a, bills 302b, spending 302c, funds 302d, and investment contributions 302e. Additional elements may be included in the client dashboard 300a and 300b without departing from the spirit or scope of the present disclosure.

For each element, the dashboard 300a and 300b may include a graphical representation of three components, which are dynamically updated in real-time: (1) an actual bar 304, (2) a plan bar 306, and (3) an expected indicator 308 on the plan bar 306. The actual bar 304 is based on actual transaction data from the transactions 118. The plan bar 306 reflects what was created in the plan for that period. The expected indicator 308 reflects where the client is on the plan bar 306 within the period in question. The dashboard 300a and 300b may include a drill down functionality when any bar of any element 302a-302e is selected. For example, if the actual bar or the plan bar is selected for the spending 302c element, the client will be provided with corresponding transaction data at a category level. For example, for a plurality of categories within the spending 302 element, the client may be provided with an actual bar, a plan bar, and an expected indicator for each category. There may be an additional drill down functionality at the category level. Specifically, the client can select the actual bar for a category and will be provided with all of the transactions associated with that category. The transactions associated with that category may be sorted by various criteria (e.g., vendor, date, account the transaction came out of, etc.). These drill down functionalities will be discussed in additional detail with reference to FIG. 6 below.

The client dashboard 300a and 300b may provide a plurality of selectable options. For instance, across the top of the client dashboard 300a and 300b, there may be a net worth selectable option 310a, an assets selectable option 312, and a liabilities selectable option 314. In the client dashboard 300a, on the left-hand side of the client dashboard 300a, there may be a net worth selectable option 310b, a cash flow mapping selectable option 316, a bills selectable option 318, an investment selectable option 320, a life time machine selectable option 322, as well as others. These selectable options may be provided anywhere on the client dashboard 300a and 300b without departing from the spirit and scope of the present disclosure.

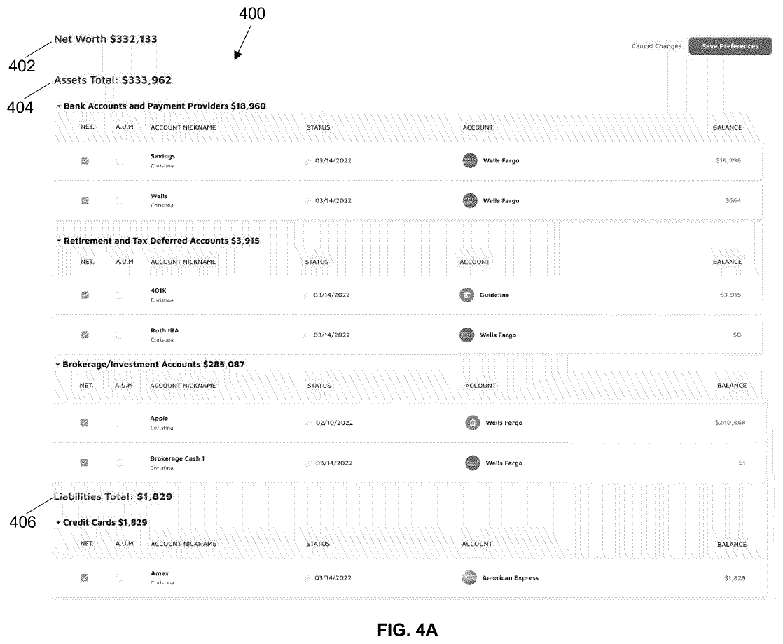

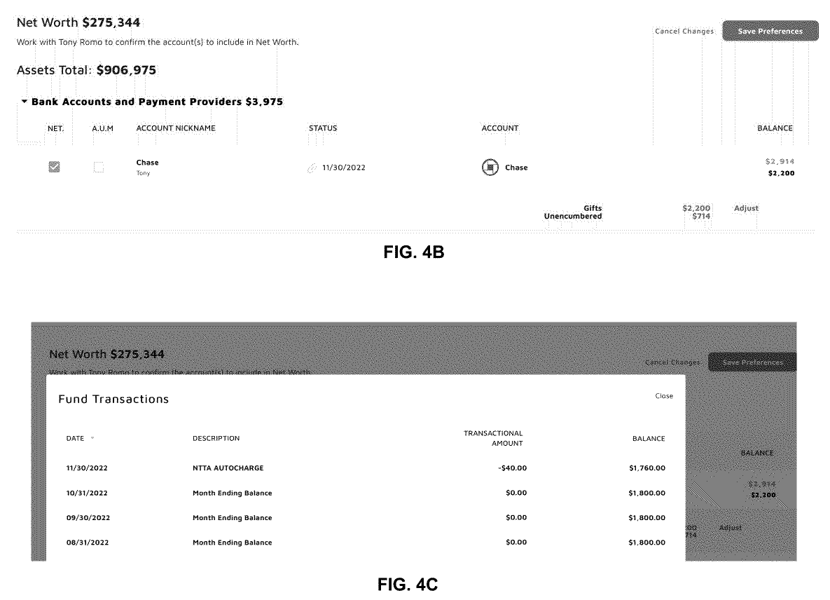

Turning now to FIG. 4A, a screenshot of a net worth screen 400 is disclosed. The net worth screen 400 may be provided by the display engine 138 and displayed via the GUI 150 on the user device 112 in response to the client selecting the net worth selectable option 310a or the net worth selectable option 310b from the client dashboard 300a or 300b. In an embodiment, the net worth screen 400 provides a net worth amount 402, an assets total 404 with a breakdown by each asset, and a liabilities total 406 with a breakdown by each liability. Although not illustrated, if the assets selectable option 310b is selected by the client from the client dashboard 300a or 300b, the client may be taken directly to the assets total 404 with the breakdown of each asset. Similarly, although not illustrated, if the liabilities selectable option 314 is selected by the client from the dashboard 300a or 300b, the client may be taken directly to the liabilities total 406 with the breakdown of each liability.

Any funds established by the client are illustrated on the net worth screen 400 under the corresponding account. The client can see what amount is encumbered based on a fund versus what is unencumbered. This can be seen with reference to FIG. 4B. If the client selects the fund, the transactions assigned to that fund are displayed. This can be seen with reference to FIG. 4C.

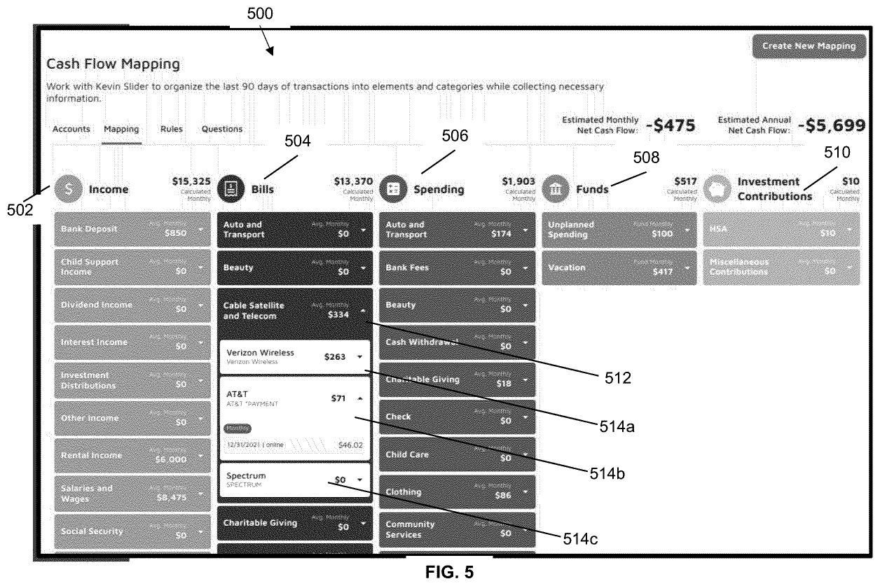

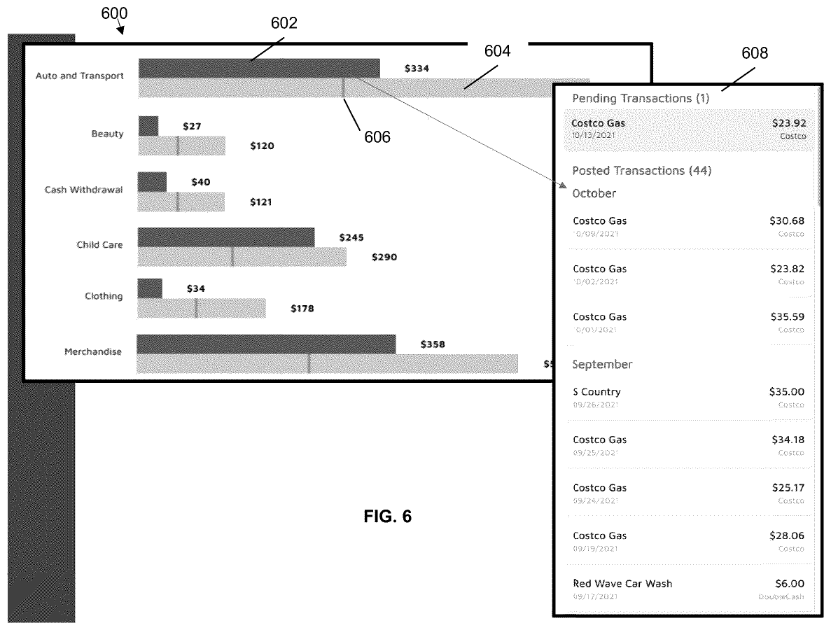

Turning now to FIG. 5, a screenshot of a cash flow mapping screen 500 is disclosed. The cash flow mapping screen 500 may be provided by the display engine 138 and displayed via the GUI 150 on the user device 112 in response to the client selecting the cash flow mapping selectable option 316 from the client dashboard 300a or 300b. In an embodiment, the cash flow mapping screen 500 provides a listing of a plurality of elements and corresponding categories associated with each element. For example, the cash flow mapping screen 500 may provide a selectable income element 502, a selectable bills element 504, a selectable spending element 506, a selectable funds element 508, a selectable investment contributions element 510, as well as other elements. In the cash flow mapping screen 500, under each element, there may be a plurality of selectable categories. Each of the categories may be selectable by a client to drill down deeper. For example, looking at the selectable bills element 502, one of the categories is a cable satellite and telecom category option 512. If a user selects the arrow to the right of that category option 512, the corresponding containers 514a-514c associated with that category are illustrated with an option to drill down further into those containers to see the transactions associated with those containers.

Turning now to FIG. 6, a screenshot illustrating a drill down category screen 600 along with a drill down transaction functionality is disclosed. The drill down category screen 600 may be provided by the display engine 138 and displayed via the GUI 150 on the user device 112 in response to the client selecting the spending elements 302 or a component (e.g., the actual bar, the plan bar, or the expected indicator) associated with the spending element from the client dashboard 300a or 300b or in response to the client selecting the selectable spending element 506 from the cash flow mapping screen 500. The drill down category screen 600 displays a plurality of categories associated with spending with each category comprising an actual bar 602, a plan bar 604, and an expected indicator 606 for that category. The actual bar 602 is based on actual transaction data from the transactions 118 categorized as within the auto and transport category. The plan bar 604 reflects what was created in the plan for the auto and transport category for that period. The expected indicator 606 reflects where the client is on the plan bar 604 within the period in question.

The drill down category screen 600 may comprise a drill down transaction functionality. In particular, a client may be able to select the actual bar 602 for a category, and a drill down transaction screen 608 may be provided to the client, which includes all of the underlying transactions categorized in that particular category from all of the client's accounts. The underlying transactions may include pending transactions as well as posted transactions. In some embodiments, the drill down transaction screen 608 may be provided as an overlay over the drill down category screen 600 as is illustrated in FIG. 6. In other embodiments, the drill down transaction screen 608 may be provided to the client as a separate screen with a selectable back option to return to the drill down category screen 600.

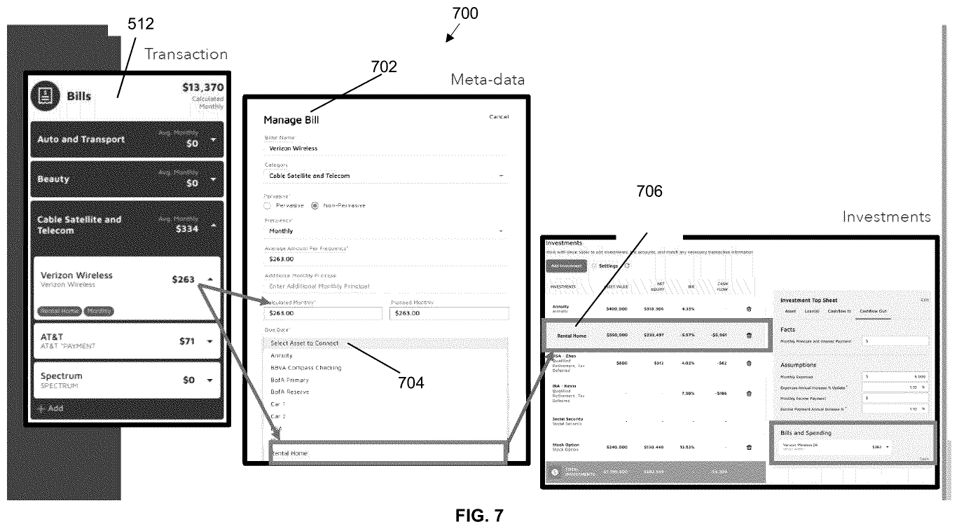

Turning now to FIG. 7, a screenshot 700 illustrating a drill down metadata functionality including a manage bill screen 702 with an asset linkage 704 is disclosed. The manage bill screen 702 may be provided by the display engine 138 and displayed via the GUI 150 on the user device 112 in response to the client selecting a selectable container within a category (e.g., the cable satellite and telecom category) of the selectable bills element 512 from the cash flow mapping screen 500. The manage bill screen 702 comprises metadata for a container such as biller name, category, whether the bill is pervasive or non-pervasive, frequency of the bill, calculated monthly amount for the bill, planned monthly amount for the bill, due date of the bill, whether the bill is tax deductible or not, and select an asset (or liability) to connect to the container. As seen in the screenshot 700, the Verizon Wireless container has an asset linkage 704 to a rental home 706. The asset linkage 704 enables integration of transaction data with a corresponding asset or liability (e.g., the rental home 706), which enables a more comprehensive insight into cost/return on the client's investments (e.g., the rental home 706).

There may be challenges associated with client dashboard 300a and 300b and the drill down category screen 600. Such challenges involve management of the expected indicator and management of the plan bar under various circumstances. A first circumstance is in regard to periodic events such as income and bills that can be inventoried. It is an insight of this disclosure that to address the first circumstance, metadata is collected by the management platform 108 that shows when the bill is expected to be paid or income is expected to be received, and the expected indicator is moved on those dates. This helps the client dashboard 300a and 300b and the drill down category screen 600 better align with the client's expectations.

A second circumstance is with respect to monthly normalization of non-monthly periodic expenses such as property taxes. In this second circumstance, and using a non-limiting property tax example, metadata is collected by the management platform 108 such that the management platform 108 knows that a property tax bill of a certain amount (e.g., $12,000) will be due by a certain date (e.g., December). It is an insight of this disclosure that to address the second circumstance, the property tax amount may be divided on a monthly basis (or whatever the client selects as the basis)—$1000 a month with the $12,000 property tax example, which affects the client's income. The property tax bill may then be normalized for the client's plan to enable the client to understand their monthly pace. However, the plan bar will not include the $1000 each month. Instead, in December, the plan bar will be $12,000, and when the property tax bill is expected to be paid, the expected indicator will move to the end of the plan bar.

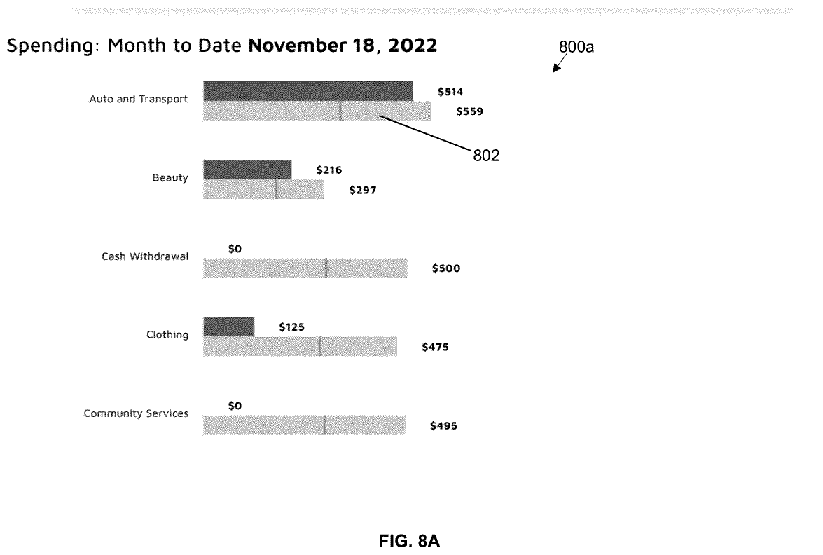

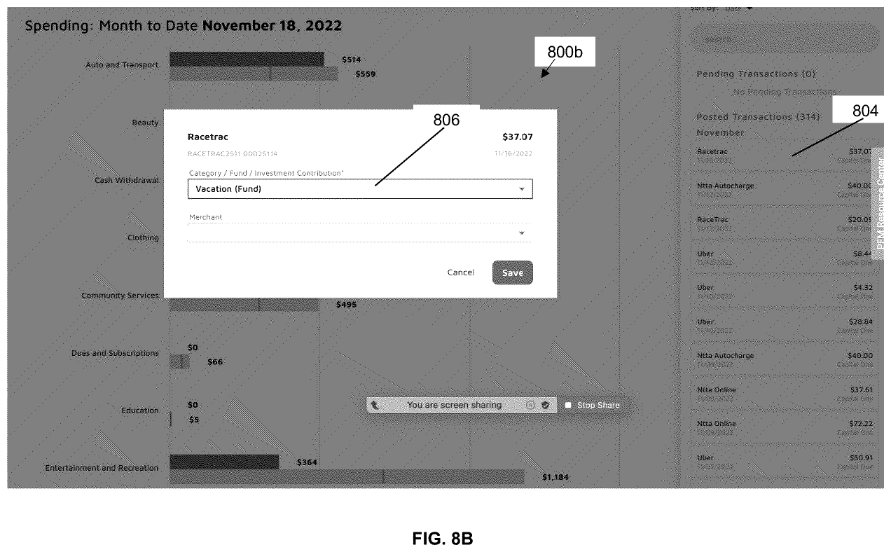

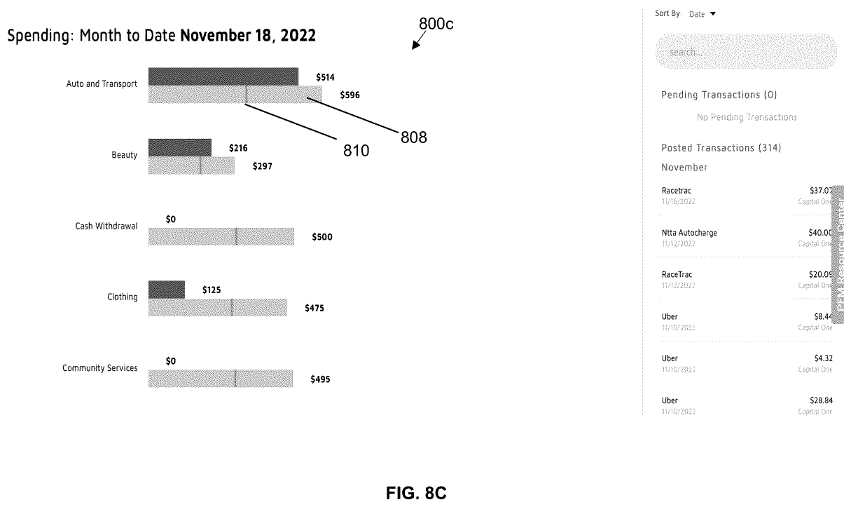

A third circumstance is in regard to assigning a transaction that has a category to a fund. FIGS. 8A-8C address this third circumstance. Turning now to FIGS. 8A-8C, a series of screenshots 800a-800c illustrating assignment of a transaction to a fund is disclosed. The screenshot 800a is similar to the drill down category screen 600 from FIG. 6. As seen in FIG. 8A, for the auto and transport category, the plan bar 802 is at $559. A client may work with their agent to set up funds for various things. The funds enable a client to set aside money (or plan to set aside money) for upcoming things. For example, the client may establish a vacation fund, a Christmas fund, or another fund. The funds may be differed spending that is being encumbered. When a fund is created, the client can determine whether to keep the fund money in the same account (but encumbered) or to transfer the fund money to a different account. Referring to FIG. 8B, the client can drill down to the transaction level as discussed with respect to FIG. 6, and select a transaction 804 to assign to a fund such as the vacation fund 806. Referring to FIG. 8C, after the client assigns the transaction 804 to the vacation fund 806, the drill down category screen 800c is dynamically updated by extending the plan bar 808 by the amount of the transaction 804. For example, as seen in FIG. 8C, for the auto and transport category, the plan bar 808 is extended by $37 to $596. The vacation fund 806 would be reduced by the amount of the assigned transaction. Although not illustrated in FIG. 8C, in an embodiment, the expected indicator 810 is moved back by the amount of the transaction 804. The assignment of transactions to funds allows a client to manage their behavior and assign transactions to funds without looking like they are going over their category budgets.

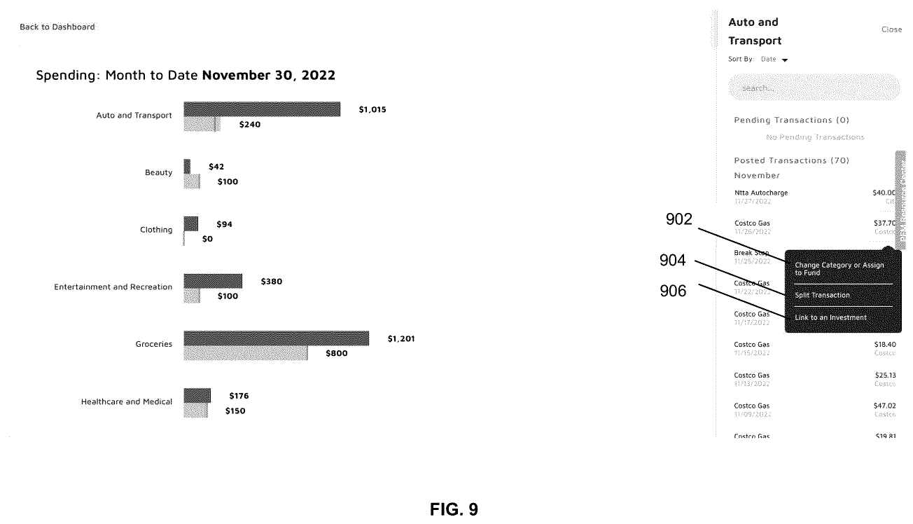

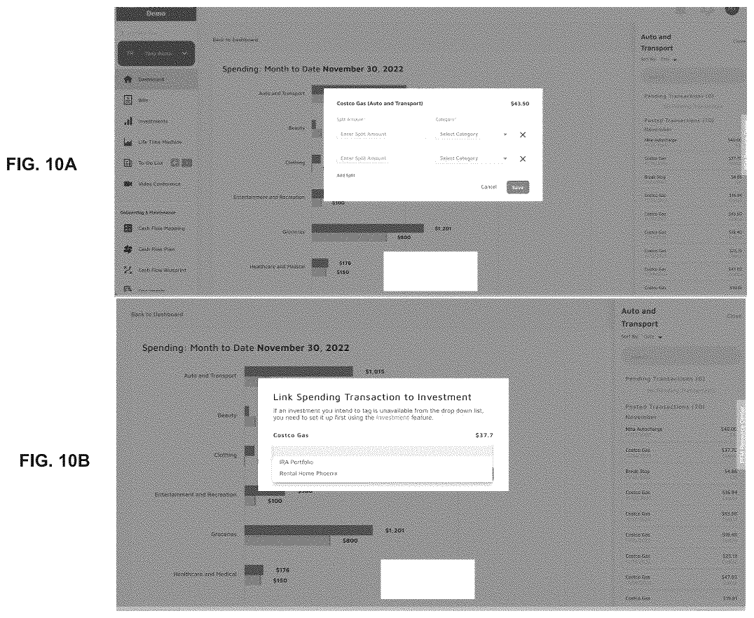

Turning now to FIG. 9, a screenshot of the drill down category screen is shown. As discussed above, if the actual bar is selected, the underlying transactions will be displayed. The transactions can be selected and a plurality of options are provided. Such options include an option 902 for changing category of the transaction or assigning the transaction to a fund. This is the option selected to assign a transaction to a fund as discussed with respect to FIGS. 8A-8C. Another option presented is an option 904 to split the transaction. If this option 904 is selected, the transaction can be split by dollar amount and those dollar amounts can be assigned to different categories. Another option presented is to an option 906 to link the transaction to an investment. If option 904 is selected, the screen presented in FIG. 10A is displayed, and the client can split a transaction. If option 906 is selected, the screen presented in FIG. 10B is displayed, and the client can select a transaction to link the transaction to.

Turning now to FIG. 11, a screenshot of a life time machine screen 1100 is disclosed. The life time machine screen 1100 may be provided by the display engine 138 and displayed via the GUI 150 on the user device 112 in response to the client selecting the life time machine selectable option 322 from the client dashboard 300a or 300b. The life time machine screen 1100 may include a net worth and cash balance graph 1102, a net cash flow graph 1104, an annual cash inflow graph 1106, and an annual cash outflow graph 1108. These graphs 1102-1108 are based on actual transaction and category as well as container level predictions. These graphs 1102-1108 also consider non-traditional investments such as rental property via the asset or liability linkages discussed above. As such, the graphs 1102-1108 are based on a more subtle and varied approach, which is more comprehensive over traditional brokerage firm type predictions. The grey vertical line represents present day. While only future predictions are present in graphs 1102-1108 represented at FIG. 11, the graphs 1102-1108 may include past data as well based on actual transactions without departing from the spirit or scope of the present disclosure.

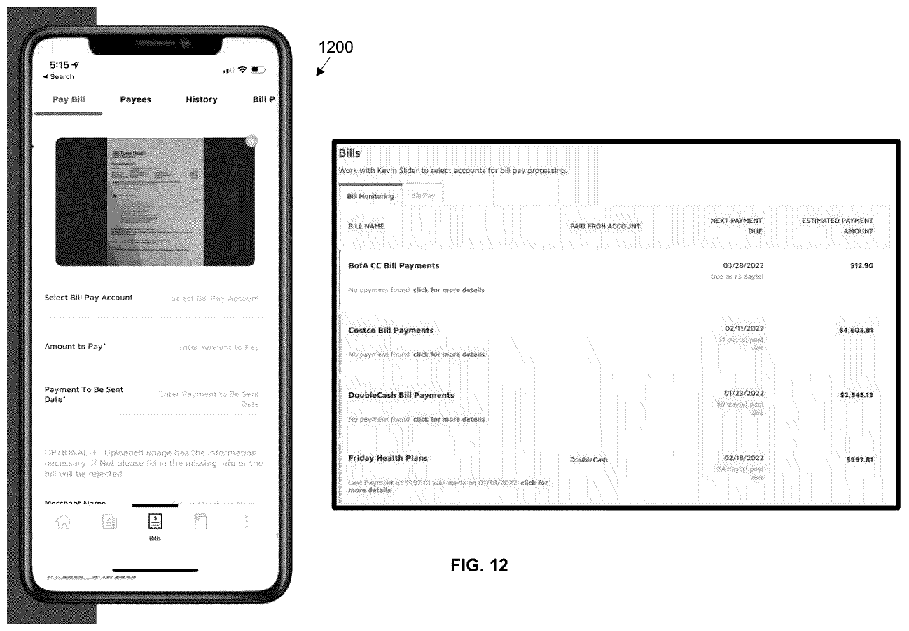

Turning now to FIG. 12, a screenshot of a bill capture screen 1200 is disclosed. The bill capture screen 1200 may be provided by the display engine 138 and displayed via the GUI 150 on the user device 112 in response to the client selecting a corresponding selectable option from the client dashboard 300a or 300b. The client may be able to take a picture of a bill using the user device 112 and the management platform 108 may process payment for the bill based on user selected parameters (e.g., bill pay account, amount to pay, payment to be sent date, etc.).

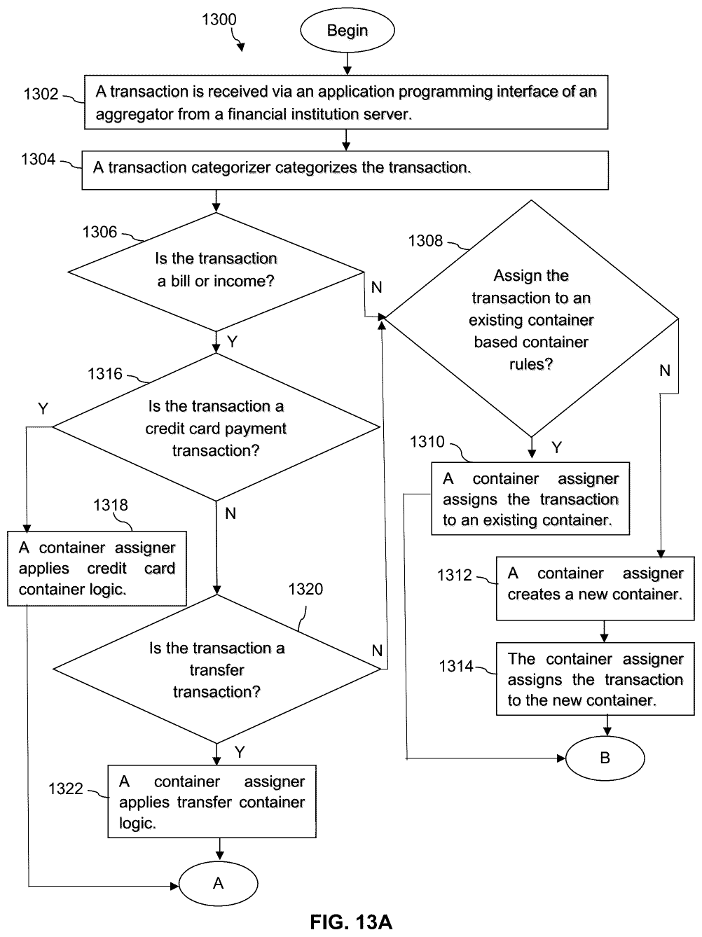

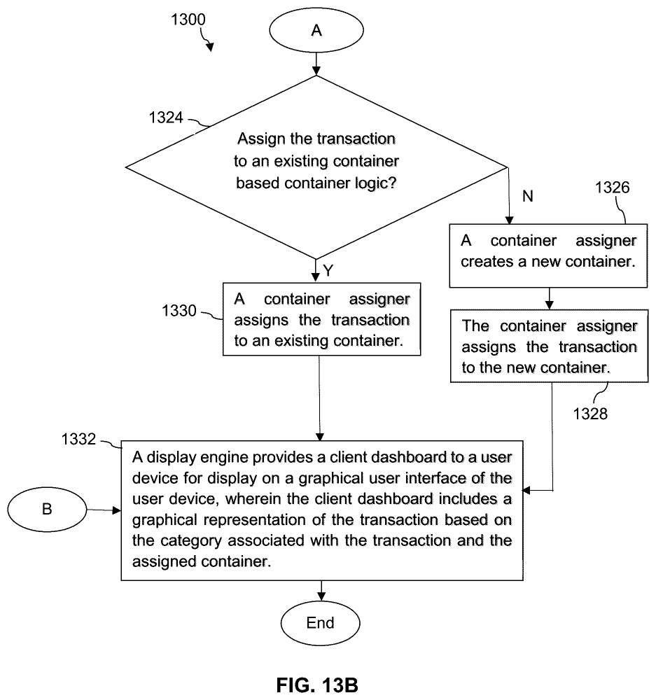

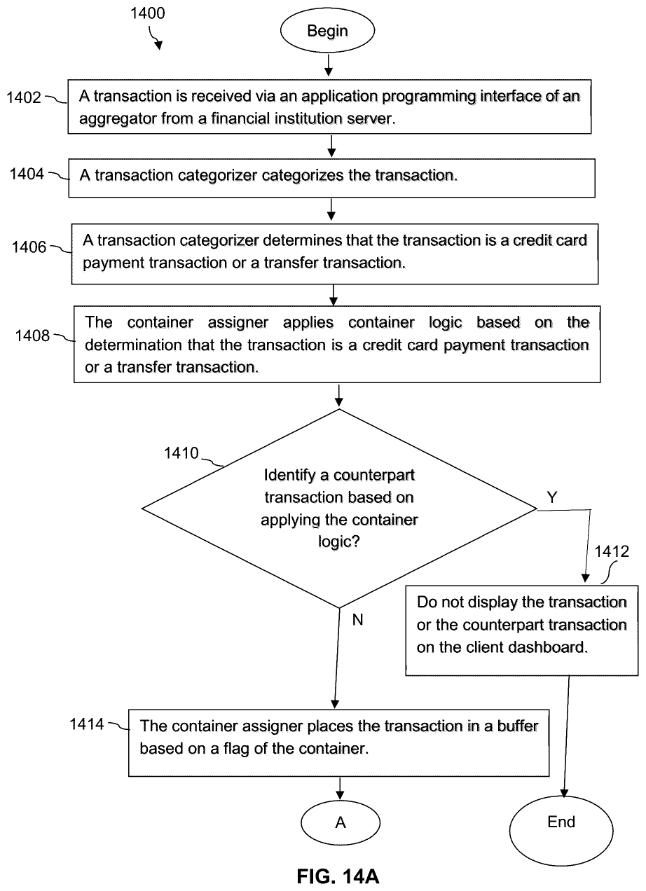

Turning now to FIGS. 13A and 13B, a containerized transaction management method 1300 is described. At block 1302, a transaction is received via an application programming interface (e.g., API 116) of an aggregator (e.g., aggregator 104) from a financial institution server (e.g., financial institution server 102). At block 1304, a transaction categorizer (e.g., transaction categorizer 130) categorizes the transaction. At block 1306, a determination is made whether the transaction is a bill or income. If the transaction is not a bill or income, at block 1308, a determination is made by a container assigner (e.g., container assigner 132) whether the transaction can be assigned to an existing container based on container rules. If the transaction can be assigned to an existing container, at block 1310, the container assigner assigns the transaction to an existing container. If the container cannot be assigned to an existing container, at block 1312, the container assigner creates a new container, and at block 1314, the container assigner assigns the transaction to the new container.

If the transaction is a bill or income, at block 1306, a determination is made by the container assigner, at block 1316, whether the transaction is a credit card payment transaction. If the transaction is a credit card payment transaction, at block 1318, the container assigner applies credit card container logic. If the transaction is not a credit card payment transaction, at block 1320, a determination is made by the container assigner whether the transaction is a transfer transaction. If the transaction is a transfer transaction, at block 1322, the container assigner applies transfer container logic. If the transaction is not a transfer transaction, the method proceeds to back to block 1308.

After the container assigner applies credit card container logic to a credit card payment transaction or transfer container logic to a transfer transaction, at block 1324, the container assigner determines whether the transaction can be assigned to an existing container based on the application of the container logic. If the container assigner cannot assign the transaction to an existing container based on the container logic, at block 1326, the container assigner creates a new container, and at block 1328, the container assigner assigns the transaction to the new container. If the container assigner can assign the transaction to an existing container based on the container logic, at block 1330, the container assigner assigns the transaction to an existing container. After the transaction is assigned to an existing container or a new container, at block 1332, a display engine (e.g., display engine 138) provides a client dashboard to a user device (e.g., client device 112) for display on a graphic user interface (e.g., GUI 150) of the user device. The client dashboard includes a graphical representation of the transaction based on the category associated with the transaction and the assigned container.

Turning now to FIGS. 14A and 14B, a containerized transaction management method 1400 is described. A block 1402, a transaction is received via an application programming interface (e.g., API 116) of an aggregator (e.g., aggregator 104) from a financial institution server (e.g., financial institution server 102). At block 1404, a transaction categorizer (e.g., transaction categorizer 130) categorizes the transaction. At block 1406, the transaction categorizer determines that the transaction is a credit card payment transaction or a transfer transaction. At block 1408, a container assigner (e.g., container assigner 132) applies container logic based on the determination that the transaction is a credit card payment transaction or a transfer transaction.

At block 1410, the container assigner makes a determination whether a counterpart transaction has been identified based on applying the container logic. If a counterpart transaction is identified at block 1410, at block 1412, the transaction and the counterpart transaction are not displayed on the client dashboard. If no counterpart transaction has been identified, at block 1414, the container assigner places the transaction in a buffer (e.g., buffer 146) based on a flag of the container. For example, if the flag is marked to “yes”, this signals that the container is to be placed in the buffer and not displayed on the client dashboard. In an embodiment, while in the buffer, the transaction is not displayed in a client dashboard presented to the client so as to not potentially confuse the client. At block 1416, a display engine (e.g., display engine 138) provides a client dashboard to a user device (e.g., user device 112) for display on a graphical user interface (e.g., GUI 150) of the user device. The client dashboard does not include the transaction in the buffer.

At block 1418, the container assigner periodically retests the transaction to determine if a new match becomes available. At block 1420, the container assigner makes a determination whether a new counterpart transaction match for the transaction has been identified. If a new counterpart transaction match is identified, at block 1422, the transaction and the counterpart transaction are not displayed on the client dashboard. If no new counterpart transaction match is identified at block 1420, at block 1424, the container assigner determines if a predetermined amount of time has passed. If the predetermined amount of time has not passed, the method proceeds back to block 1420 to try to identify a new counterpart transaction match. If the predetermined amount of time has passed, at block 1426, the container assigner displays the transaction on the client dashboard.

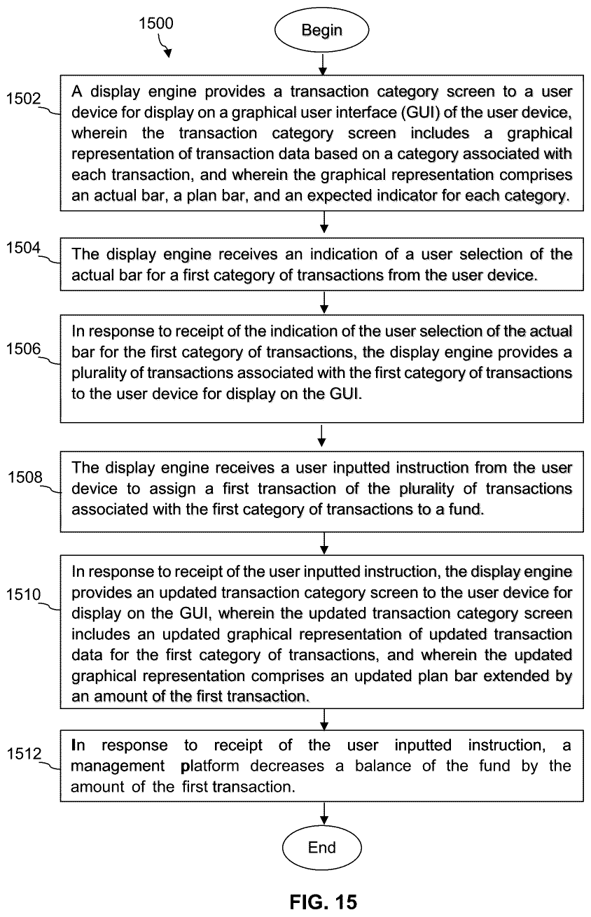

Turning now to FIG. 15, a containerized transaction management method 1500 is described. A block 1502, a display engine (e.g., display engine 138) provides a transaction category screen to a user device (e.g., user device 112) for display on a graphical user interface (GUI) (e.g., GUI 150) of the user device. The transaction category screen includes a graphical representation of transaction data based on a category associated with each transaction. The graphical representation comprises an actual bar, a plan bar, and an expected indicator for each category. At block 1504, the display engine receives an indication of a user selection of the actual bar for a first category of transactions from the user device. At block 1506, in response to receipt of the indication of the user selection of the actual bar for the first category of transactions, the display engine provides a plurality of transactions associated with the first category of transactions to the user device for display on the GUI.

At block 1508, the display engine receives a user inputted instruction from the user device to assign a first transaction of the plurality of transactions associated with the first category of transactions to a fund. At block 1510, in response to receipt of the user inputted instruction, the display engine provides an updated transaction category screen to the user device for display on the GUI. The updated transaction category screen includes an updated graphical representation of updated transaction data for the first category of transactions. The updated graphical representation comprises an updated plan bar extended by an amount of the first transaction. At block 1512, in response to receipt of the user inputted instruction, a management platform (e.g., management platform 108) decreases a balance of the fund by the amount of the first transaction.

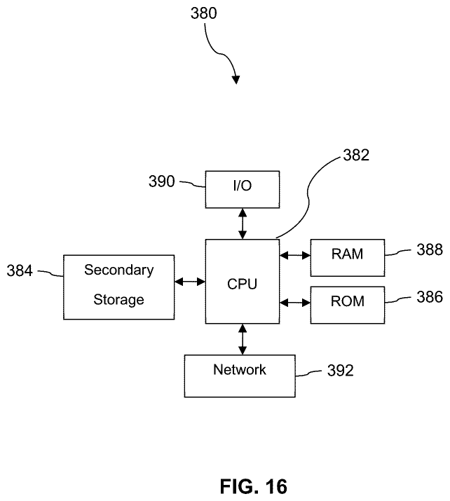

FIG. 16 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise a paper tape, a magnetic tape, magnetic disk, an optical disk, a solid state memory chip, analog magnetic tape, compact disk read only memory (CD-ROM) disks, floppy disks, jump drives, digital cards, multimedia cards, and others, without limitation. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A containerized transaction management method, comprising:
receiving, by a management platform, a transaction associated with a client from an aggregator;
categorizing, by a transaction categorizer stored in a non-transitory memory of the management platform and executed by a processor of the management platform, the transaction as a credit card payment transaction or a transfer transaction;
applying, by a container assigner stored in the non-transitory memory and executed by the processor, container logic based on a determination that the transaction is a credit card payment transaction or a transfer transaction;
determining, by the container assigner, whether a counterpart transaction is identified based on applying the container logic;
in response to a determination that no counterpart transaction is identified, placing, by the container assigner, the transaction in a buffer based on a flag of the container;
providing, by a display engine stored in the non-transitory memory and executed by the processor, a client dashboard to a user device for display on a graphical user interface (GUI) of the user device, wherein the client dashboard comprises a graphical representation that does not include the transaction in the buffer; and
periodically retesting, by the container assigner, the transaction to determine if a new matching counterpart transaction becomes available within a predefined amount of time.

2. The method of claim 1, wherein the predefined amount of time is between four and seven days.

3. The method of claim 2, wherein the predefined amount of time is five days.

4. The method of claim 1, further comprising:
identifying the new matching counterpart transaction within the predetermined amount of time based on the periodic retesting;
in response to identifying the new matching counterpart transaction:
removing the transaction from the buffer; and
providing, by the display engine, an updated client dashboard to the user device for display on the GUI, wherein the updated client dashboard does not include the transaction or the new matching counterpart transaction.

5. The method of claim 1, wherein the graphical representation comprises an actual bar, a planned bar, and an expected indicator for each element of a plurality of elements.

6. The method of claim 1, further comprising in response to no new matching counterpart transaction being available within the predefined amount of time, providing, by the display engine, an updated client dashboard to the user device for display on the GUI, wherein the updated client dashboard comprises an updated graphical representation that includes the transaction.

7. A containerized transaction management system, comprising:
a management platform comprising:
a non-transitory memory;
a processor; and
a display engine stored in the non-transitory memory that, when executed by the processor:
provides a transaction category screen to a user device associated with a client for display on a graphical user interface (GUI) of the user device, wherein the transaction category screen includes a graphical representation of transaction data based on a category associated with each transaction, and wherein the graphical representation comprises an actual bar, a plan bar, and an expected indicator for each category,
receives an indication of a user selection of the actual bar for a first category of transactions from the user device,
in response to receipt of the indication of the user selection of the actual bar for the first category of transactions, provides a plurality of transactions associated with the first category of transactions to the user for display on the GUI,
receives a user inputted instruction from the user device to assign a first transaction of the plurality of transactions associated with the first category of transactions to a fund, and
in response to receipt of the user inputted instruction, provides an updated transaction category screen to the user device for display on the GUI, wherein the updated transaction category screen includes an updated graphical representation of updated transaction data for the first category of transactions, and wherein the updated graphical representation comprises an updated plan bar expended by an amount of the first transaction.

8. The system of claim 7, wherein in response to receipt of the user inputted instruction, the management platform decreases a balance of the fund by the amount of the first transaction.

9. The system of claim 7, wherein the updated graphical representation further comprises an updated expected indicator moved back on the updated plan bar by the amount of the first transaction.

10. The system of claim 7, wherein the management component further comprises a transaction categorizer stored in the non-transitory memory that, when executed by the processor, categorizes transactions for the client into one of a plurality of categories.

11. The system of claim 10, wherein the transaction categorizer categorizes the transactions based on applying three tiers of categorization.

12. The system of claim 7, wherein the management component further comprises a container assigner stored in the non-transitory memory that, when executed by the processor, assigns at least some of the transactions to one or more containers.

13. The system of claim 12, wherein a container of the one or more containers links two or more transactions together, comprises any rules applied to the two or more transactions, and includes a linkage to an asset, wherein the display engine is further configured to provide a life time machine screen to the user device for display in the GUI, and wherein the life time machine screen is based on the linkage included in the container.

14. A containerized transaction management method, comprising:
receiving, by a management platform, a plurality of transactions associated with a client from an aggregator;
categorizing, by a transaction categorizer stored in a non-transitory memory of the management platform and executed by a processor of the management platform, the plurality of transactions based on applying three tiers of categorization such that each transaction is as associated with a category of a plurality of categories, wherein the three tiers of categorization applied to a first transaction of the plurality of transactions comprises a first tier of categorization based on applying a client rule when the client rule for the first transaction exists, a second tier of categorization based on applying a system rule when no client rule for the first transaction exists but the system rule for the first transaction exists, and a third tier of categorization based on applying a default categorization determined based on externally provided transaction information when no client rule or system rule exists for the first transaction;
assigning, by a container assigner stored in the non-transitory memory and executed by the processor, at least some of the plurality of transactions to containers based on container rules;
linking, by a linkage component stored in the non-transitory memory and executed by the processor, at least one container to an asset; and
providing, by a display engine stored in the non-transitory memory and executed by the processor, a client dashboard to a user device for display on a graphical user interface of the user device, wherein the client dashboard includes a graphical representation of the plurality of transactions based on the associated categories and the assigned containers.

15. The method of claim 14, further comprising promoting, by a machine learning (ML) component stored in the non-transitory memory and executed by the processor, the client rule to a new system rule.

16. The method of claim 15, further comprising:
receiving, from the aggregator, at least one transaction associated with a different client; and
categorizing, by the transaction categorizer, the at least one transaction based on applying the new system rule such that the at least one transaction is as associated with a category of the plurality of categories.

17. The method of claim 14, wherein the at least one container links two or more transactions together, comprises any rules applied to the two or more transactions, and includes the linkage to the asset.

18. The method of claim 14, wherein the graphical representation comprises an actual bar, a planned bar, and an expected indicator.

19. The method of claim 14, further comprising:
linking, by the linkage component, the asset to an investment; and
providing, by the display engine, investment information for the investment to the user device for display on the GUI, wherein the investment information for the investment includes any transactions linked to the asset via the at least one container.

20. The method of claim 19, further comprising providing, by the display engine, a life time machine screen to the user device for display on the GUI, wherein the life time machine screen is based on the investment information for the investment as well additional asset to investment linkages.
